(19) United States
(12) Patent Application Publication
(10) Pub. No.: US 2003/0126812 A1
(43) Pub. Date: Jul. 10, 2003

(54) Casement window

(76) Inventors: Peter Folsom, Bronxville, NY (US); Helmut Schmidt, Unionville (CA)

Correspondence Address: DARA L ONOFRIO, ONOFRIO LAW, 1133 BROADWAY, SUITE 1600, NEW YORK, NY, 10010, US

(21) Appl. No.: 10/138,110

(22) Filed: May 2, 2002

Related U.S. Application Data
(60) Provisional application No. 60/288,508, filed on May 3, 2001.

(51) Int. Cl. E06B 3/964

(52) U.S. Cl. 52/204.62; 52/204.61

(57) ABSTRACT

A casement window or door comprised of a glass unit and pultruded fiberglass lineals which are formed into a frame having a narrow sightline. The window is thermally and acoustically efficient.

This application claims the benefit of U.S. provisional application no. 60/288,508 filed May 3, 2001, which is incorporated herein by reference.

### FIELD OF THE INVENTION

The present invention relates to a pultruded fiberglass casement window or door having a narrow sightline and is thermally and acoustically efficient.

### BACKGROUND OF THE INVENTION

Window replacements for existing steel casement windows, especially in Historic Landmark Districts is difficult. The Landmarks Preservation Commission mandates that in designated locations new windows must replicate old window in profile and outward appearance. In particular, the “sightline” of the new window must be as narrow as that of the old window and have the same “shadow line” detail.

The old non-thermal windows had very narrow frames, due in part to single glazing (non insulated glass) and in part because they have no “thermal barrier” (insulation incorporated within the metal frame to keep cold air which contacts the outside of the frame from being passed right through the metal of the frame in contact with room-side air) and have little, if any, integral weather-stripping. Modern steel casement window manufacturers substituted insulated glass for single glass only served to take away some of the shadow-line detail of the old windows. With the addition of thicker insulated glass, the glass fills the glazing space and eliminates the room for the “putty-line” aspect of the old window profile—the sloped putty section which held the glass in the old steel frames. Current modern steel window fabricators, however, have done little to better weather-strip their windows, leaving them drafty, inefficient thermally and acoustically.

The present invention incorporates a glazing space for full one-inch insulated glass, a superior weather-stripping system and a thermally efficient frame material. The pultruded fiberglass needs no “thermal barrier” as it is a thermally efficient material. In addition, this window system has the same “sightline” (frame width) as the heavy intermediate steel casement window. It is much narrower than aluminum or vinyl imitations. The pultruded fiberglass also is very strong, will not rust, rot or corrode, as will steel or aluminum.

Accordingly, it is a broad object of the invention to provide a pultruded fiberglass casement window which can be used as a window or door. Throughout the specification the term casement window is meant to refer to applications as a window as well as a door.

A specific object of the invention is to provide a casement window which has a narrower sightline (frame width) than other operable casement windows with a thermally insulated frame and glass.

A more specific object of the invention is to provide a fiberglass casement window that is more thermally and acoustically efficient than any other casement window even with a 20% wider frame. The invention casement window passed the highest classification water infiltration test (ASTM E 331, WTP=12 psf) that the American Architectural Manufacturer's Association recognizes.

Another more specific object of the invention is to provide a fiberglass casement window that recreates the historic putty line exterior profile of the old steel non-thermal casement windows.

Another more specific object of the invention is to create a thermally and acoustically efficient window retaining the sightlines and charm of the old steel casement windows. Historically correct cast bronze scroll handles and bronze friction bar hardware complete the look of a historic replication.

### SUMMARY OF THE INVENTION

In general, the invention provides a casement window or door comprised of a glass unit and pultruded fiberglass lineals which are formed into a sash frame and a main frame having a narrow sightlines. The window is thermally and acoustically efficient and further has a lower air infiltration and a higher resistance to water penetration than traditional steel casement windows.

More particularly, the invention provides a casement window comprising: a glass unit; a glazing space for the glass unit; and a frame made of a thermally efficient material. The glass unit and said frame are structurally bonded to combine the strength of the glass with the strength of the frame to produce a casement window that is thermally and acoustically efficient.

Preferably the glass unit is insulated glass, but single pane glass can be used. Typically the glazing space accommodates glass up to one inch thick, however other thicknesses less than or greater than one inch can be used in the invention windows.

In preferred embodiments the thermally efficient frame material is pultruded fiberglass. Additionally, the frame material has grooves and slots for the incorporation of a weather stripping material which may be co-extruded dual durometer gaskets, foam filled bulb gaskets, generic vinyl bulb gaskets, other thermoplastic bulb or lip gaskets or other conventional weather stripping materials.

The casement window according to the invention further comprises a sash system that is preferably structurally glazed.

The sash system comprises fiberglass sash profiles which are u-shaped pieces that fit around the edges of an insulated glass unit. A structural sealant is used to bond the insulated glass and fiberglass sash profiles together. The sealant used is selected from the group consisting of silicones, urethanes or polysulfides.

The sash frame exhibits a substantial sloped surface portion which recreates the traditional appearance of a putty line.

The casement window frame is comprised of pultruded fiberglass lineals which are formed into a frame having a narrow sightline. As previously stated the window is thermally and acoustically efficient and further has a lower air infiltration and a higher resistance to water penetration than traditional steel casement windows.

Other objects, features and advantages of the present invention will be apparent when the detailed description of the preferred embodiments of the invention are considered with reference to the drawings, which should be construed in an illustrative and not limiting sense as follows:

### BRIEF DESCRIPTION OF THE DRAWINGS

FIGS. 1A and 1B are cross-section illustrations of the casement window according to the invention at section A-A;

FIGS. 2A and 2B are cross-section illustrations of the casement window according to the invention at section B-B;

FIGS. 3A and 3B are cross-section illustrations of the casement window according to the invention at section C-C;

FIGS. 4A and 4B are cross-section illustrations of the casement window according to the invention at section D-D;

FIGS. 5A and 5B are cross-section illustrations of the casement window according to the invention at section E-E;

FIGS. 6A and 6B are cross-section illustrations of the casement window according to the invention at section F-F;

FIGS. 7A and 7B are cross-section illustrations of the casement window according to the invention at section G-G;

FIGS. 8A and 8B are cross-section illustrations of the casement window according to the invention at section G′-G′;

FIGS. 9A and 9B are cross-section illustrations of the casement window according to the invention at section H-H;

FIGS. 10A and 10B are cross-section illustrations of the casement window according to the invention at section H′-H′;

FIGS. 11A and 11B are cross-section illustrations of the casement window according to the invention at section J-J;

FIG. 12 is an exterior view of a casement window according to the invention;

FIG. 13 is an exterior view of another embodiment of a casement window according to the invention;

FIG. 14 is an exterior view of another embodiment of a casement window according to the invention;

FIG. 15 is an exterior view of another embodiment of a casement window according to the invention;

FIG. 16 is an exterior view of another embodiment of a casement window according to the invention;

FIG. 17 is an exterior view of another embodiment of a casement window according to the invention;

FIG. 18 is an illustration of the putty line grid;

FIG. 19 is an illustration of the flat muntin grid;

FIG. 20 is an illustration of a casement window according to the invention;

FIG. 21 is another illustration of a casement window according to the invention;

FIG. 22 is another illustration of a casement window according to the invention;

FIG. 23 is an illustration of the installation of the casement window according to the invention;

FIG. 24 is another illustration of the installation of the casement window according to the invention; and

FIG. 25 illustrates various sash and frame combinations for perimeter and mullion situations.

### DETAILED DESCRIPTION OF THE INVENTION

In accordance with the present invention a pultruded fiberglass casement window having a narrow sightline is provided that is thermally and acoustically efficient.

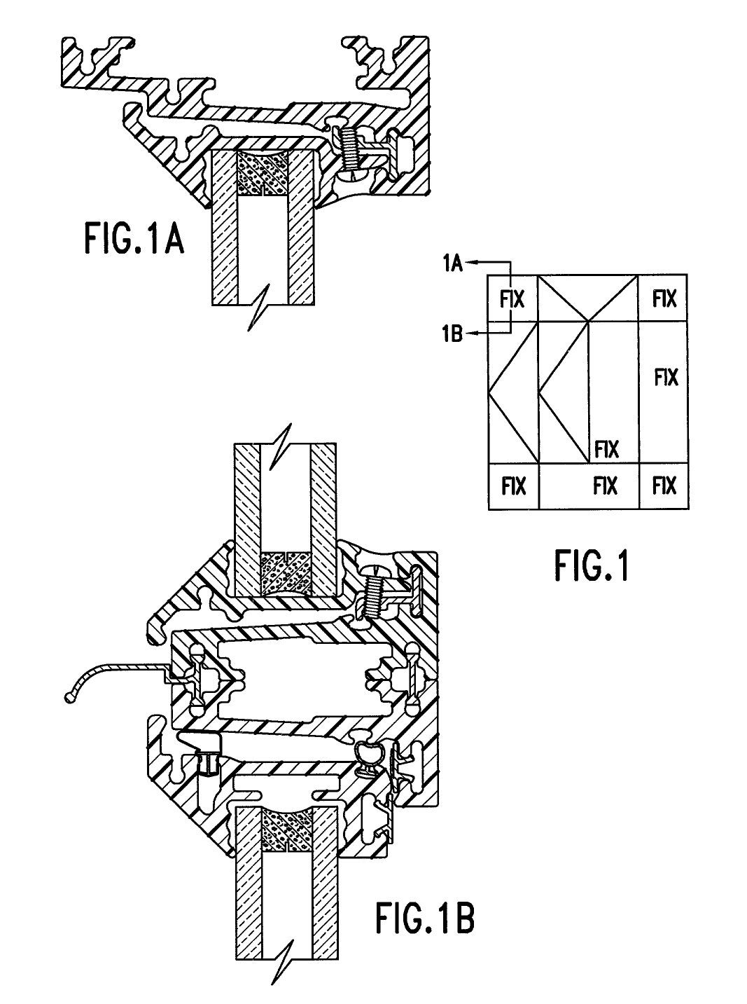

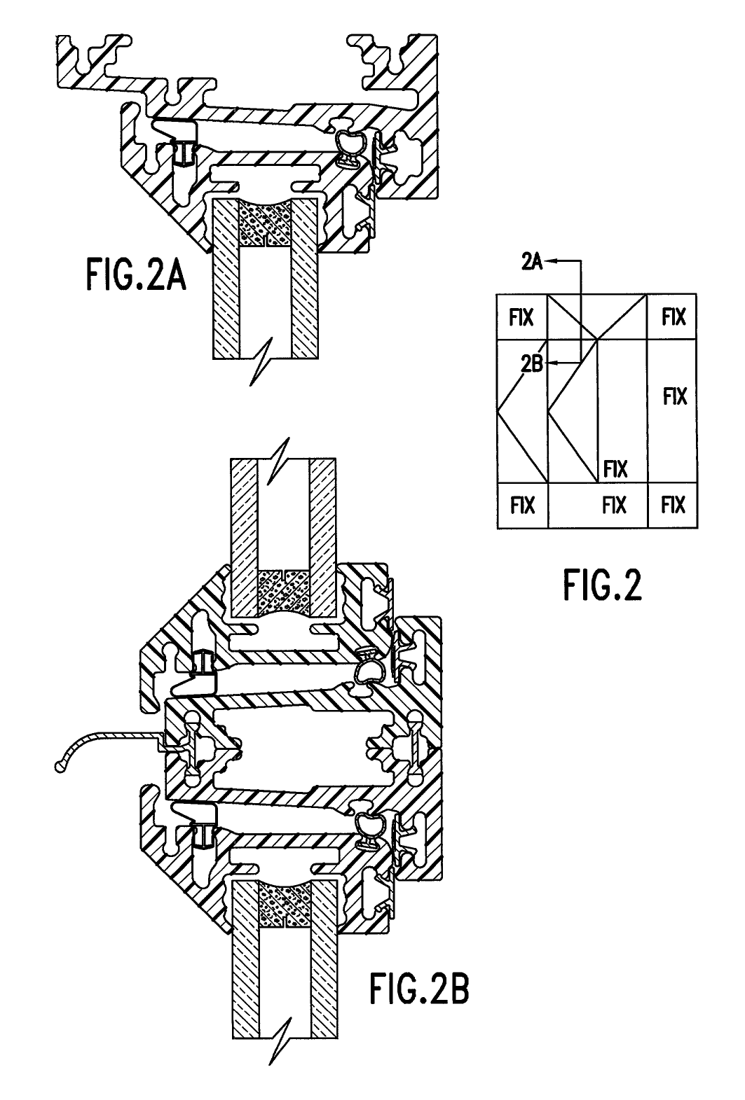

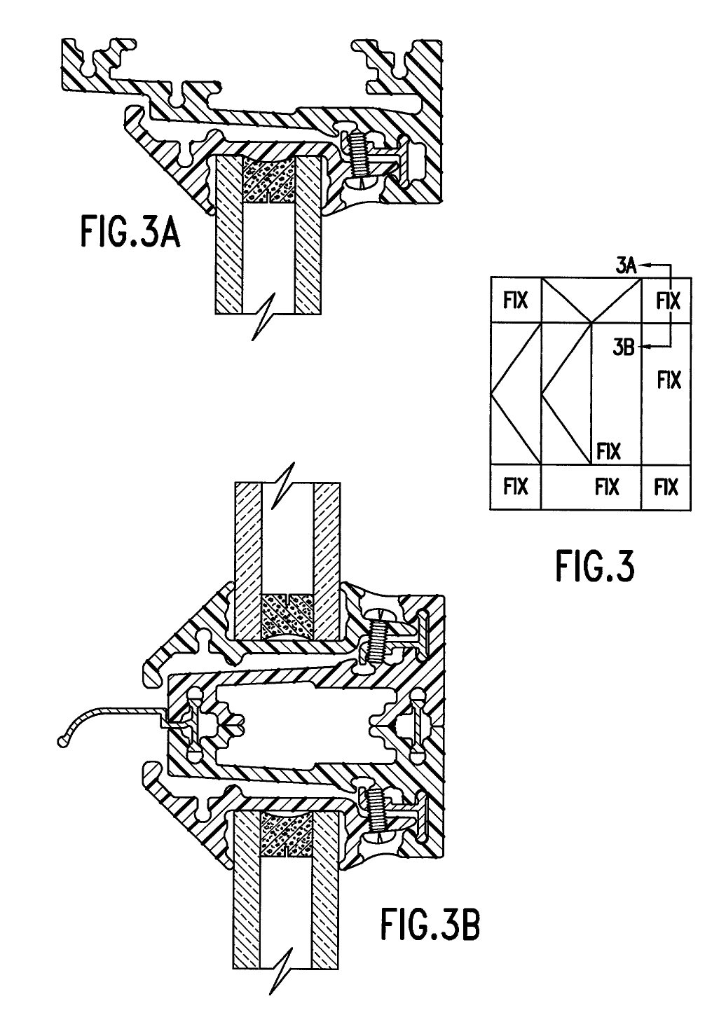

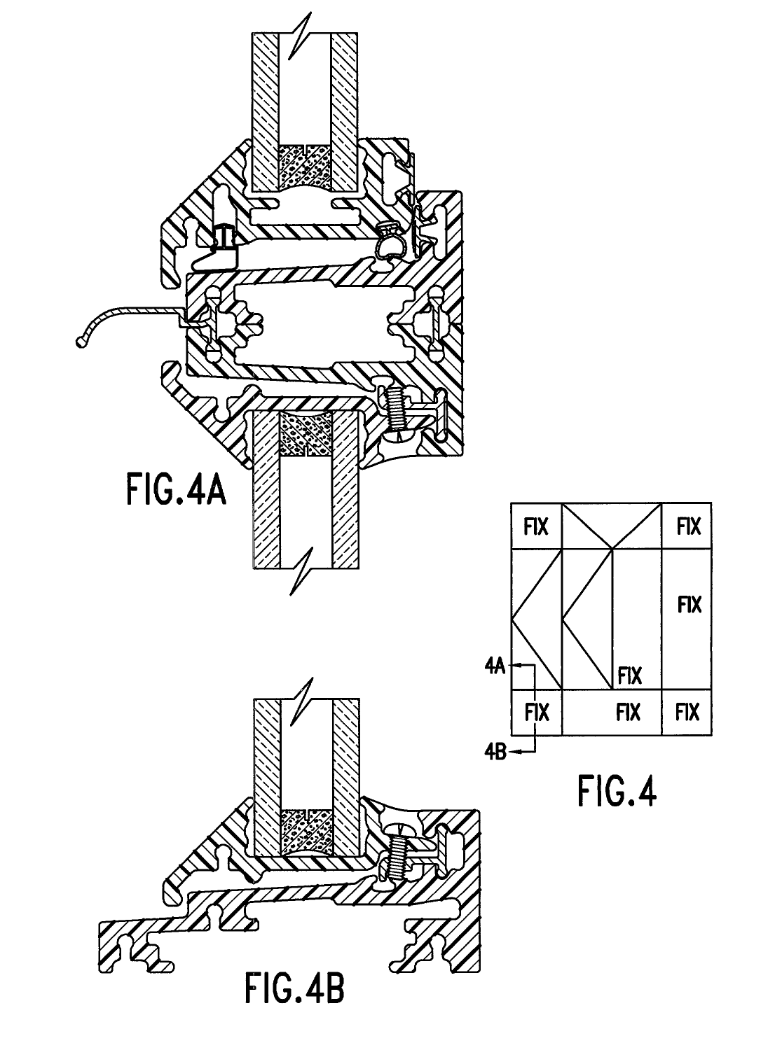

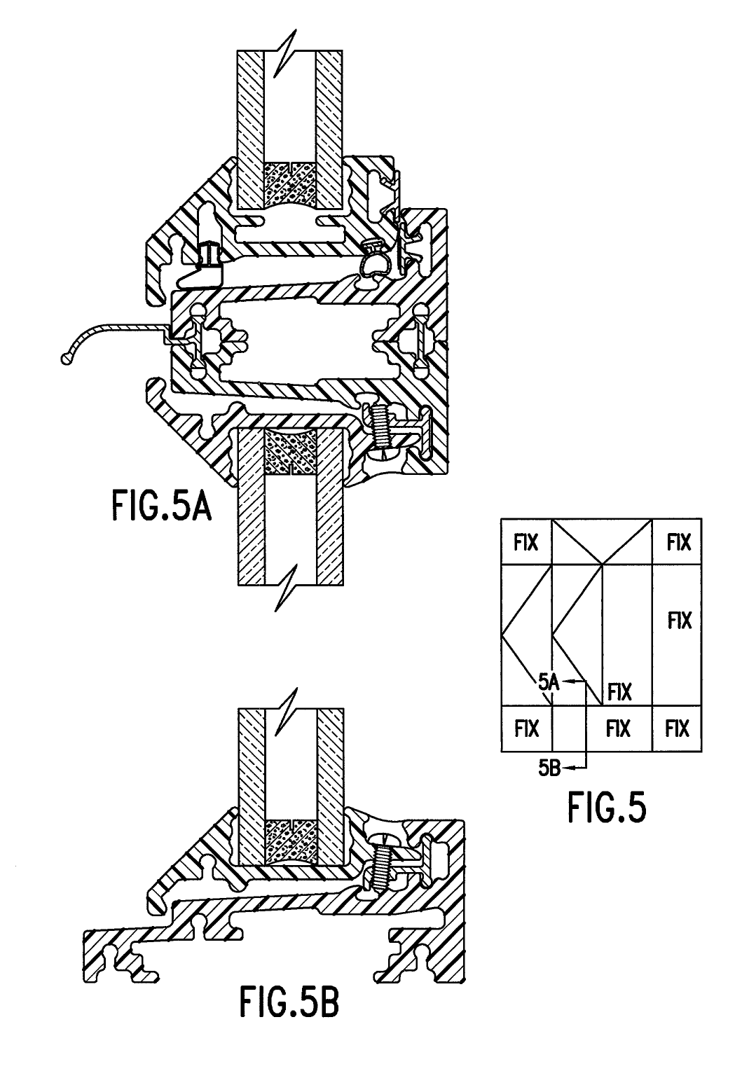

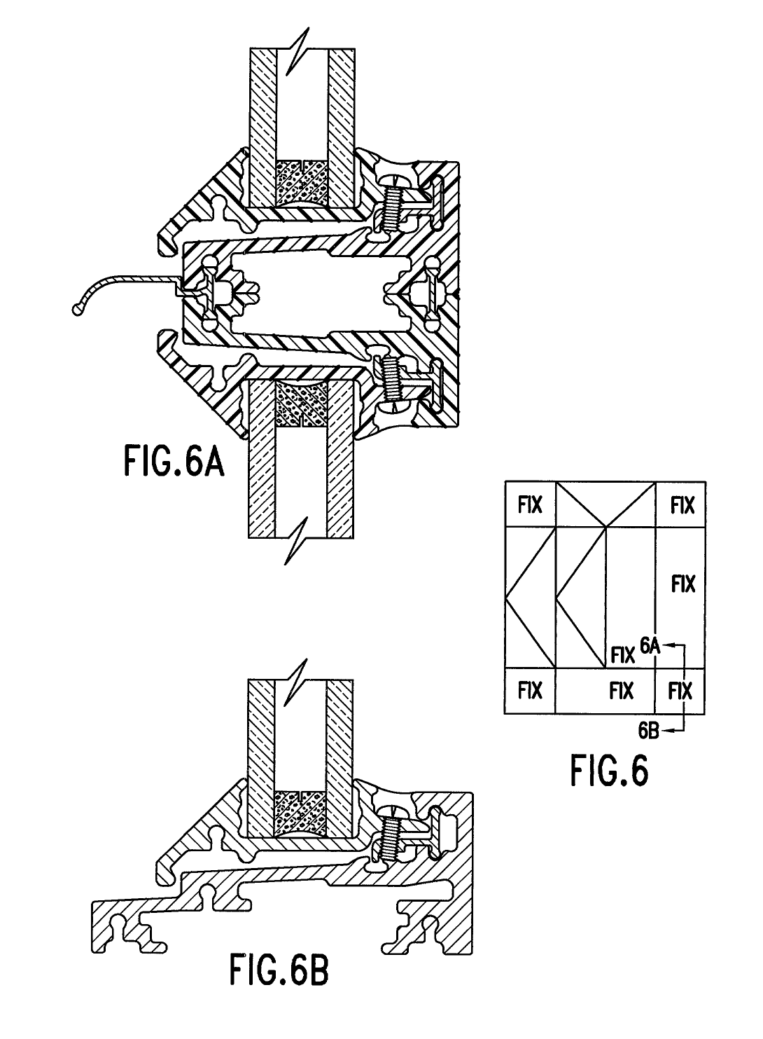

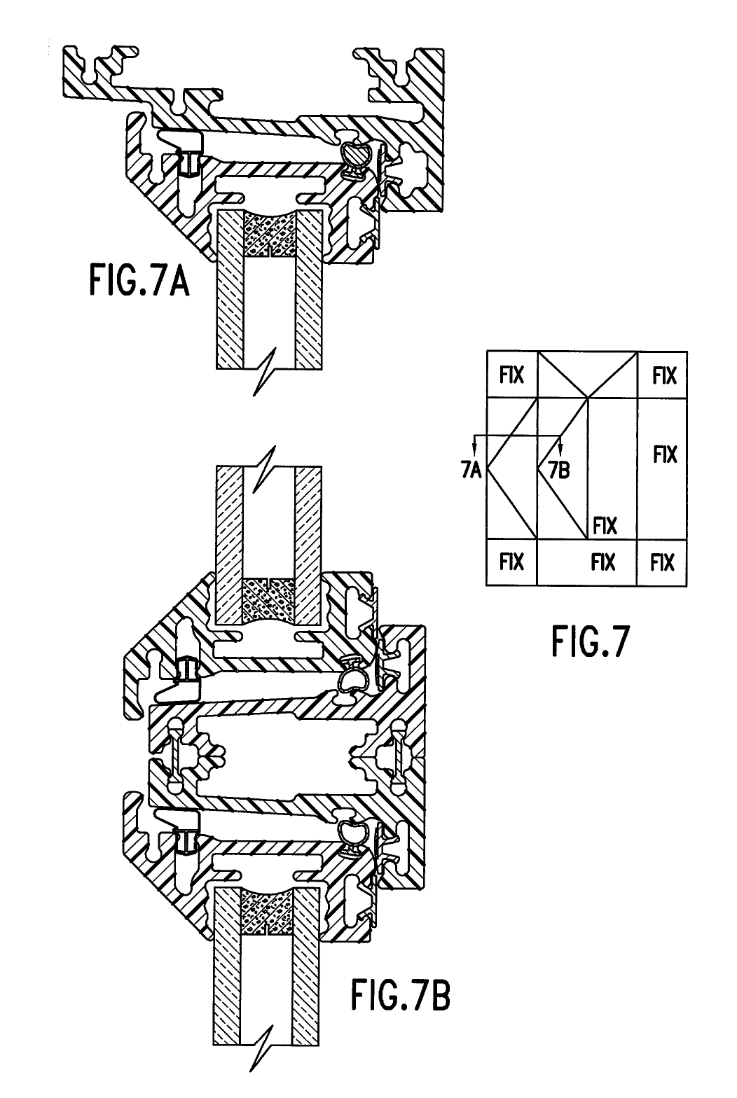

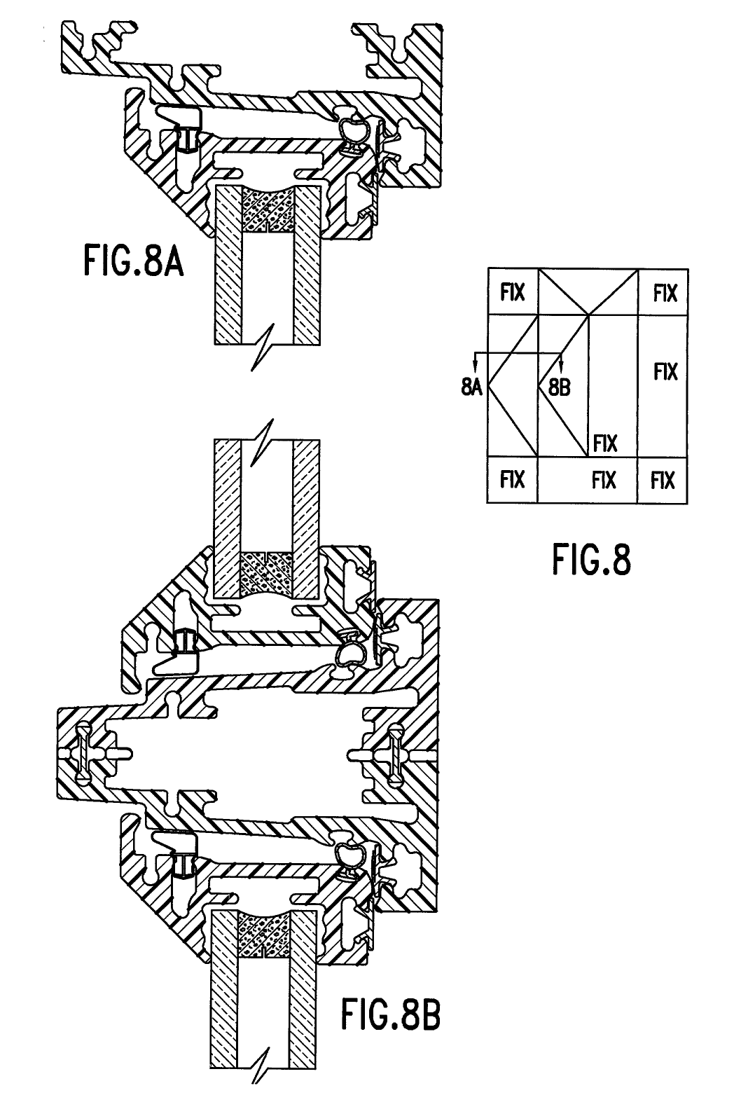

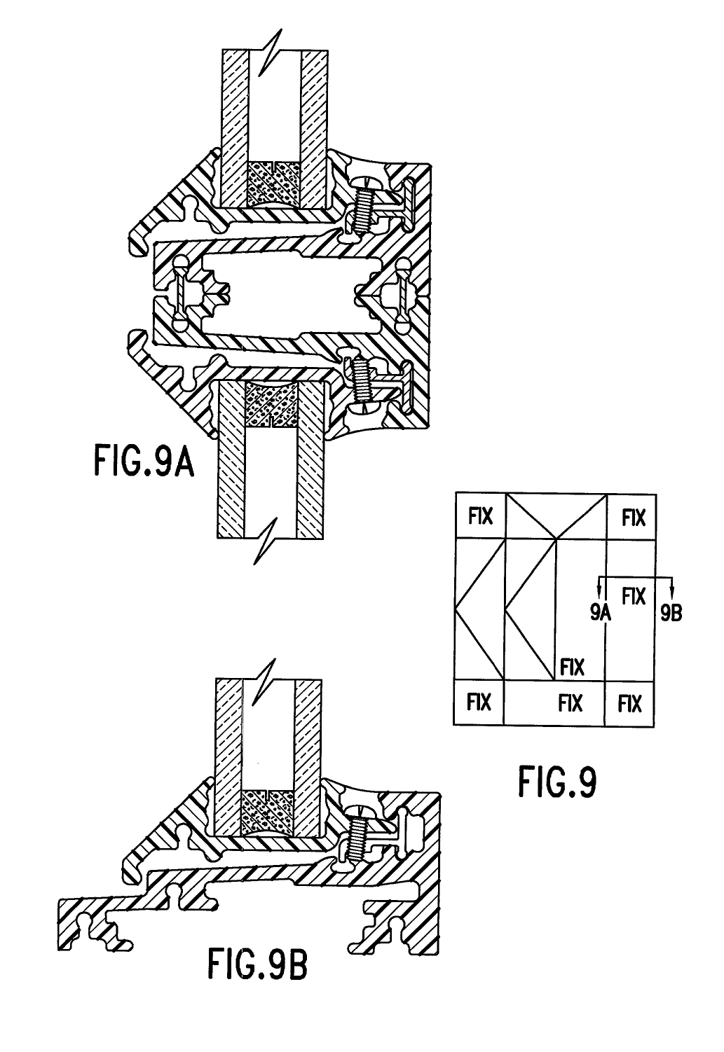

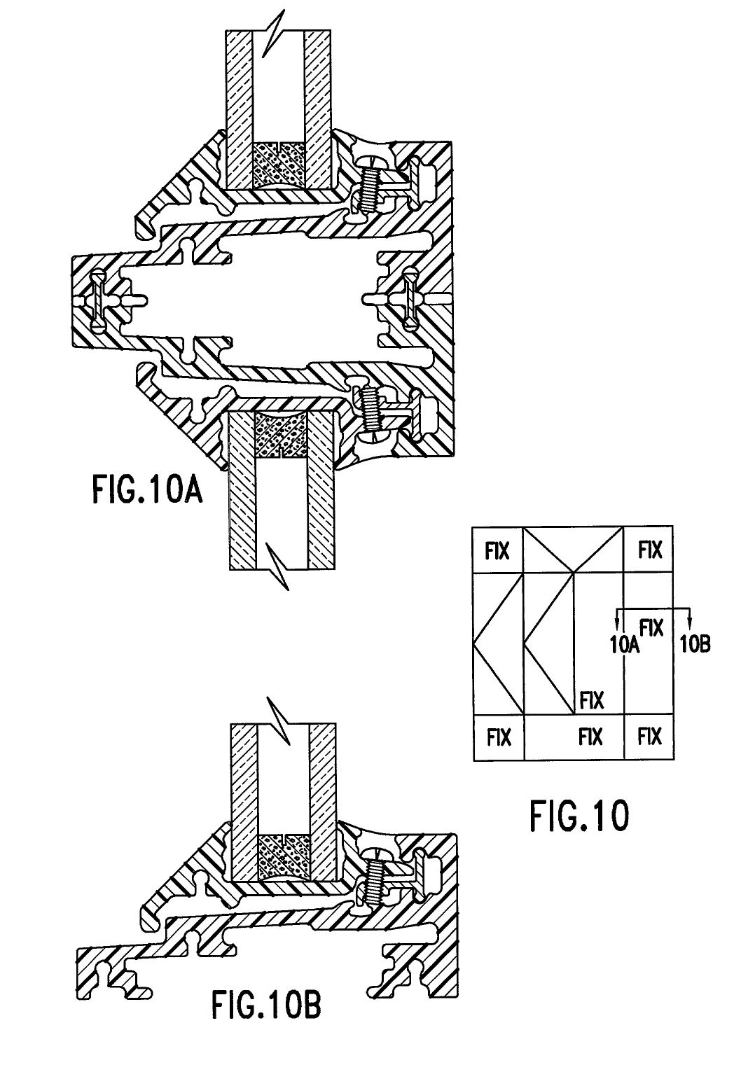

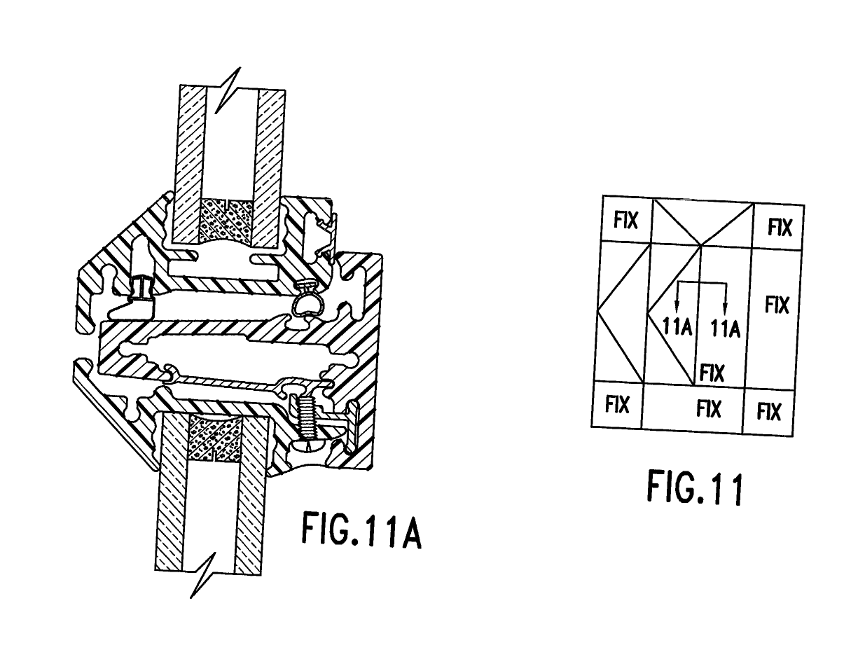

FIGS. 1 thru 11 are cross-section illustrations of the casement window according to the invention at various sections of the window.

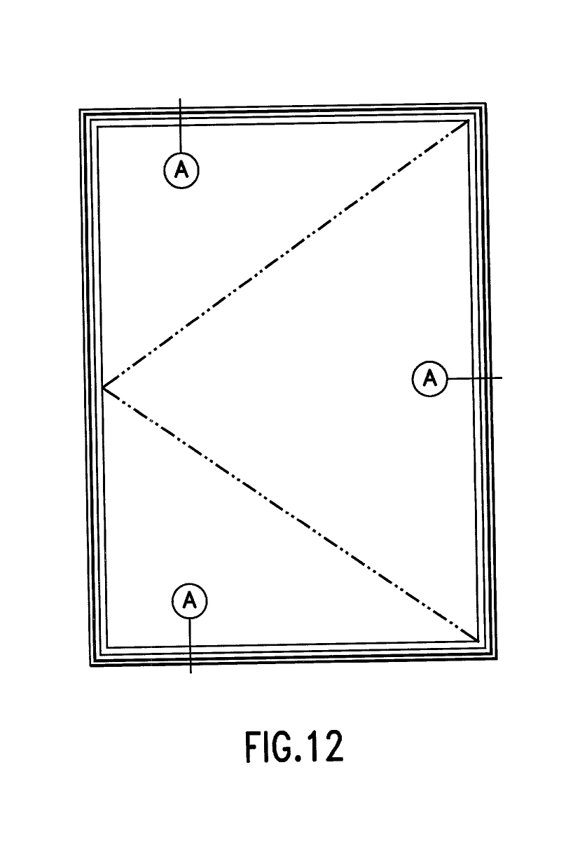

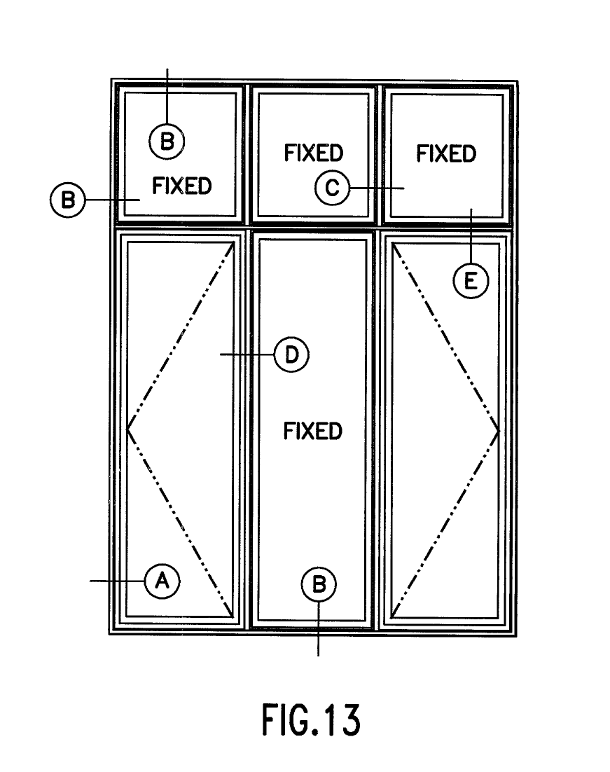

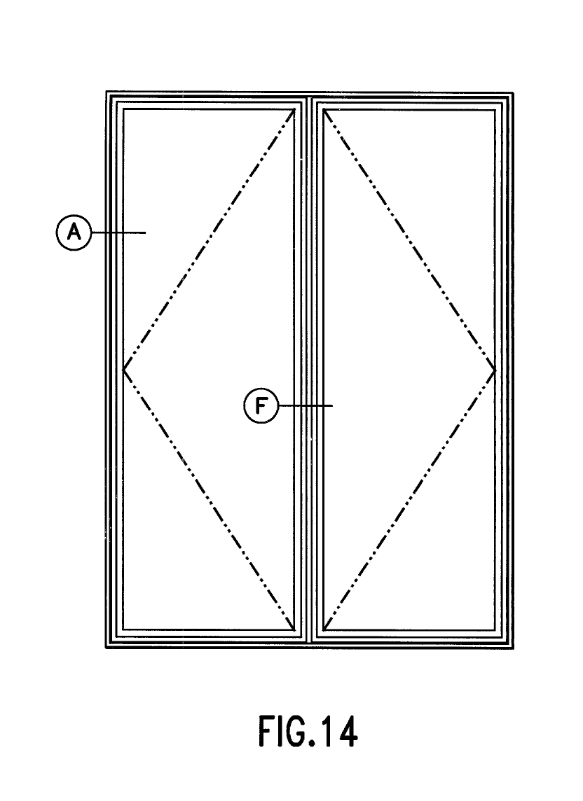

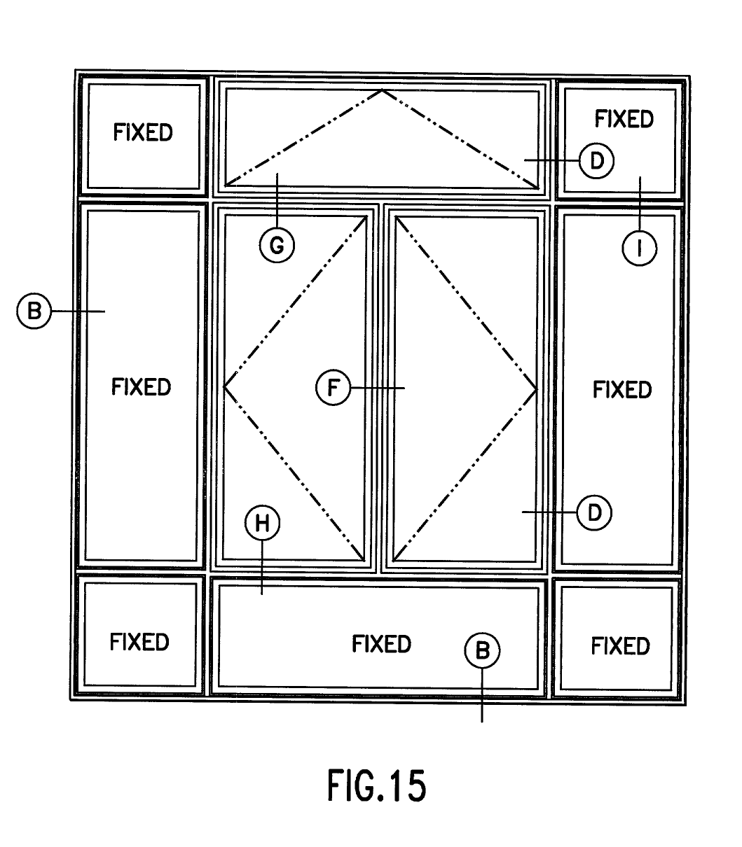

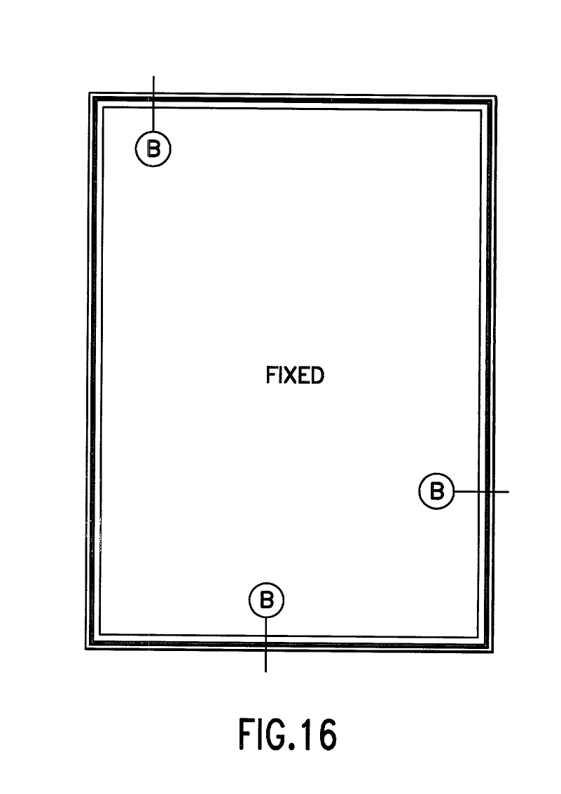

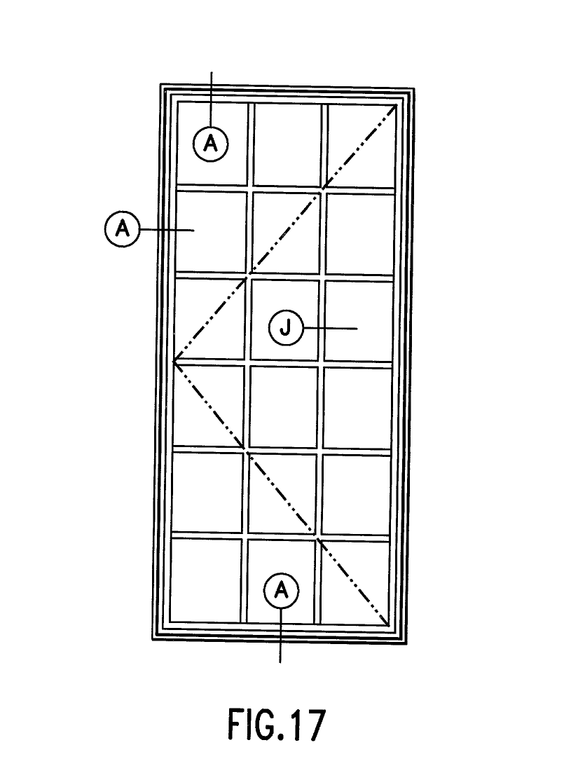

FIGS. 12 thru 17 illustrate exterior views of embodiments of casement windows according to the invention.

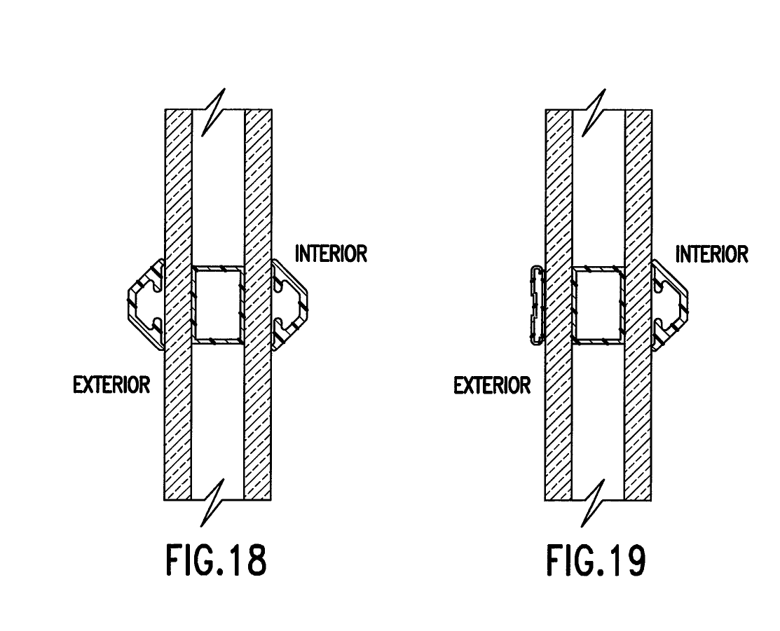

FIG. 18 is an illustration of a putty line grid anad FIG. 19 is an illustration of a flat muntin grid which may be used in the invention windows.

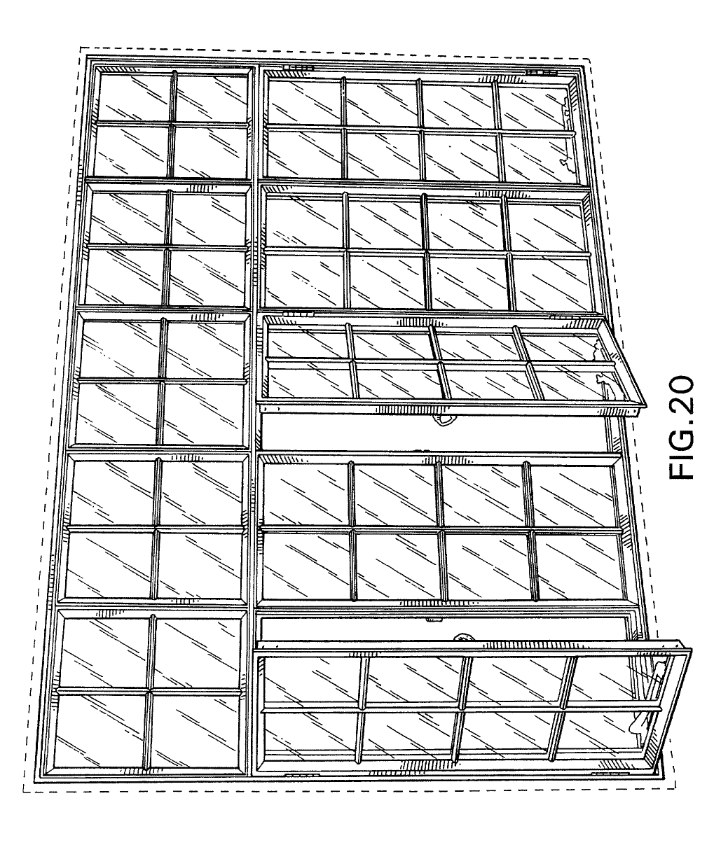

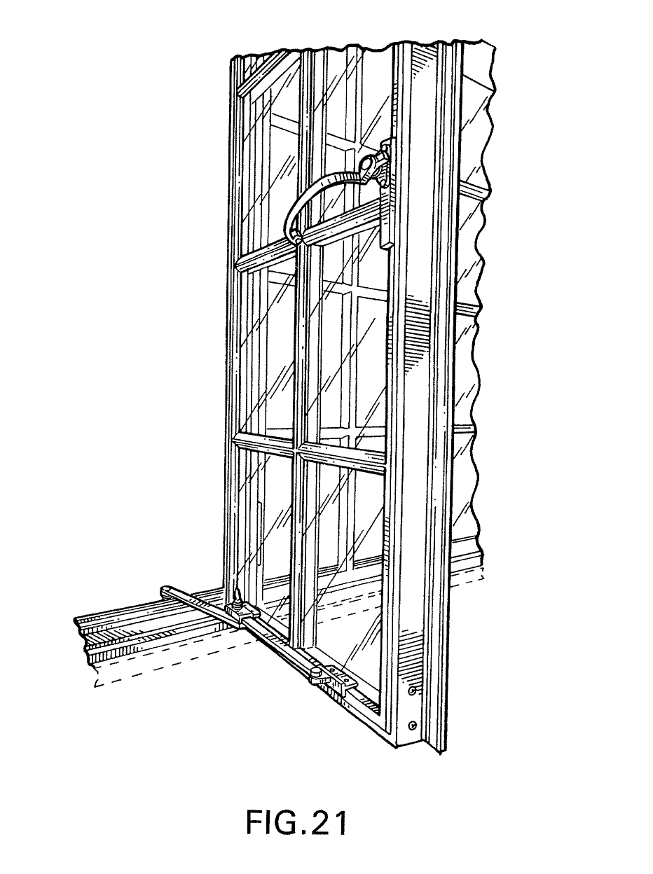

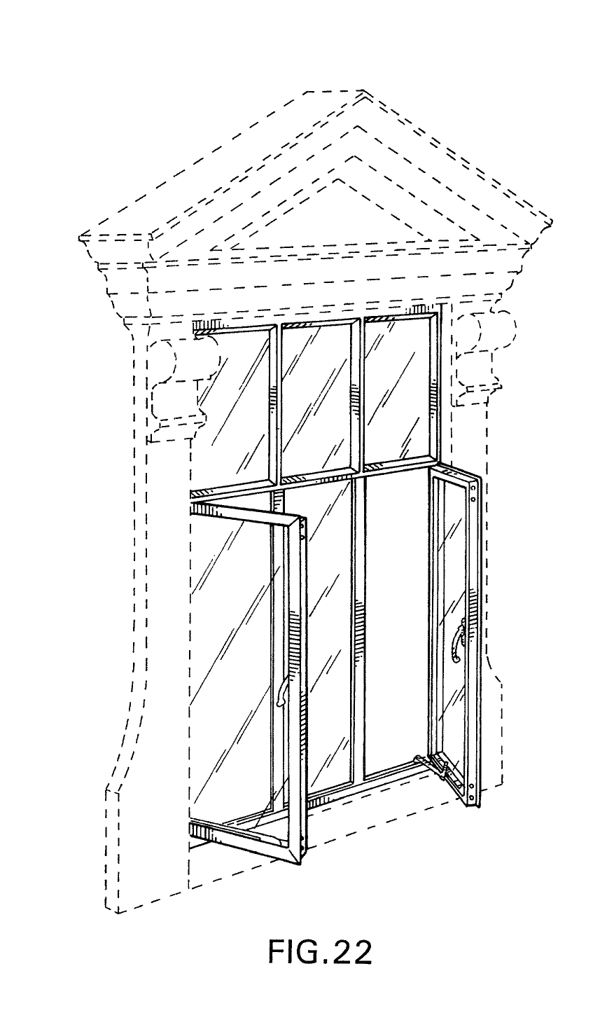

FIGS. 20 thru 22 are illustrations of casement windows according to the invention.

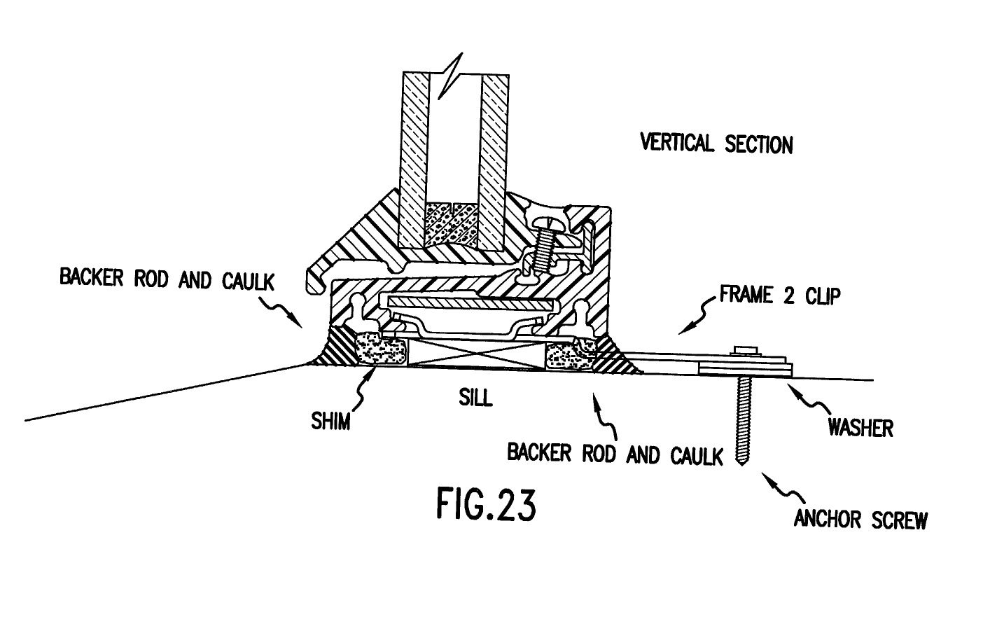

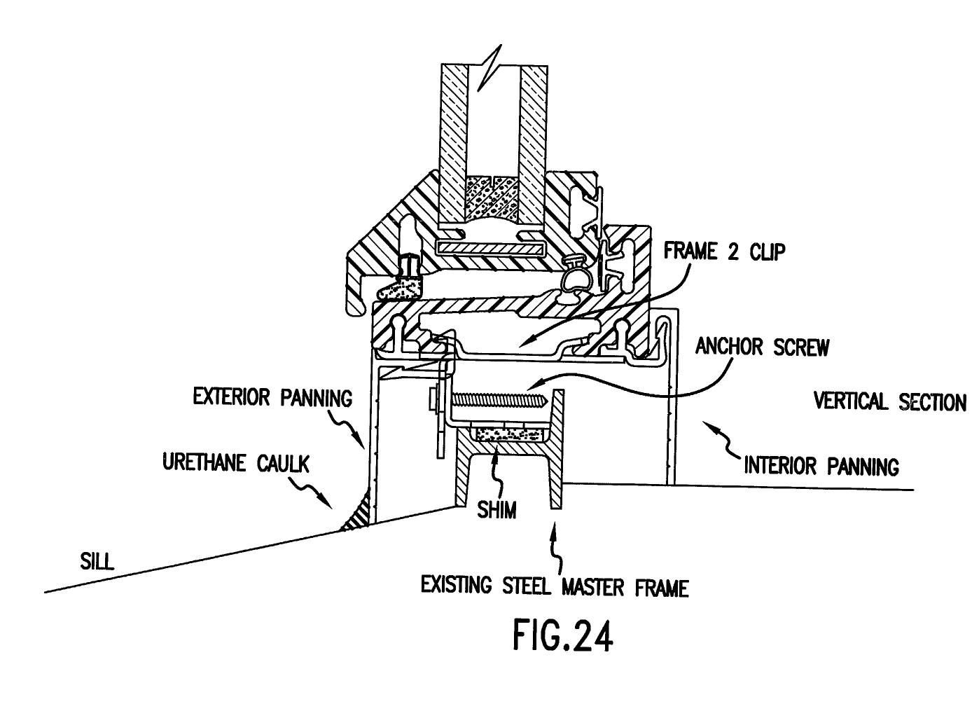

FIGS. 23 and 24 are illustrations of installation of the casement window according to the invention.

The invention relies upon “pultruded” fiberglass to make it practical. Pultruded fiberglass takes fiberglass yarn and matts and feeds them into a die form, arranging the fiberglass content carefully within the shape to promote maximum strength. Mats as well as yarn are needed because the transverse nature of the glass orientation in the mats gives strength. When in the proper position and being pulled through the die, resins are added to solidify the shape. The glass fiber content gives the shape its strength and the resins stabilize it in place. The glass content in a high quality window is approximately 60-65%.

The casement window according to the invention uses a structurally glazed sash system. The sash profiles are u-shaped pieces which fit around the edges of the insulated glass unit. A structural sealant, such as silicones, urethanes or polysulfides, is used to bond the insulated glass and fiberglass sash profiles together, giving the sash the added strength of the insulated glass unit itself.

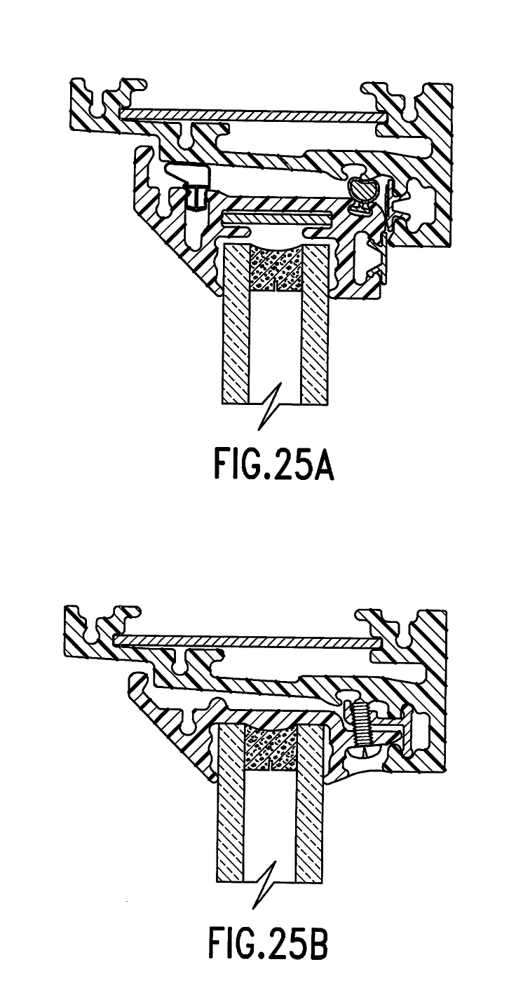

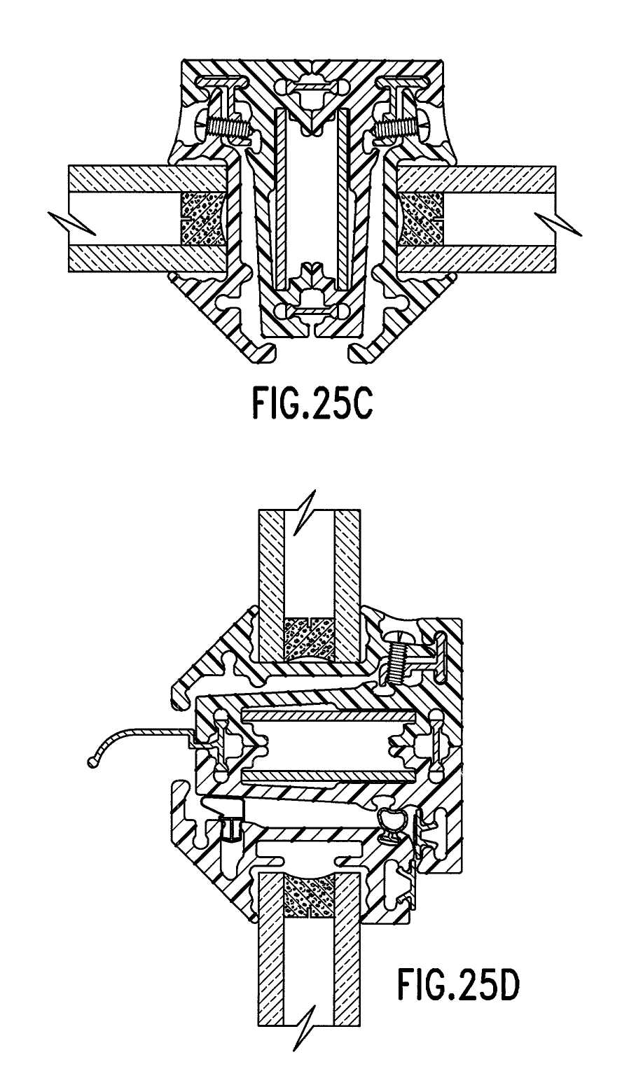

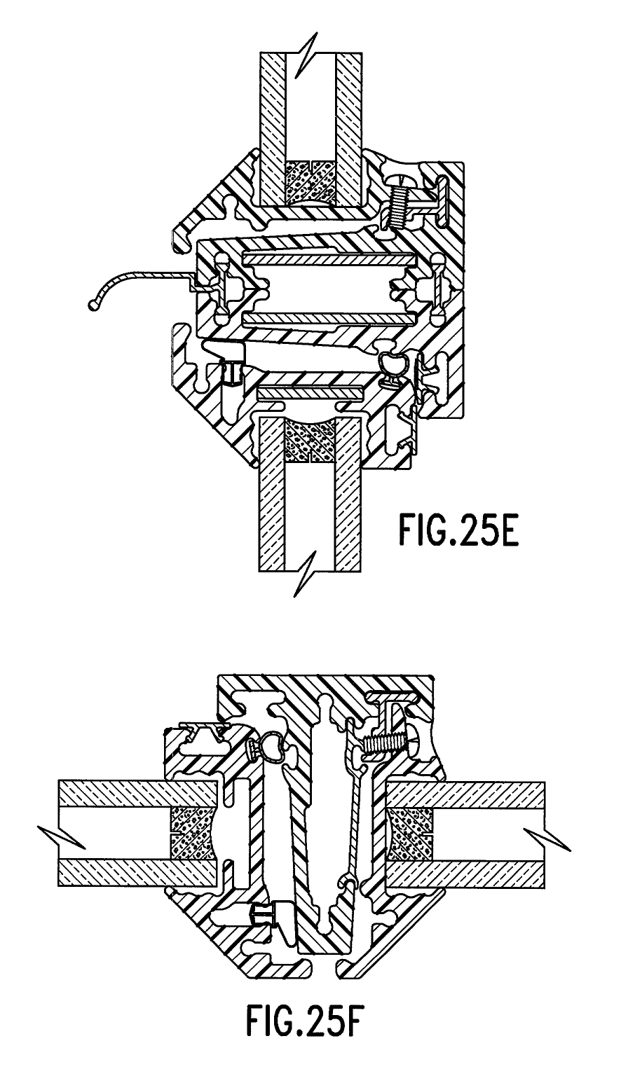

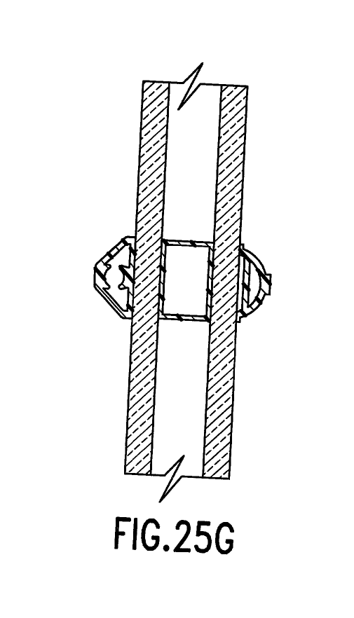

The frame sections themselves may have grooves or slots in them to incorporate different weather stripping materials at different locations. The frame sections are miter cut and screwed together with aluminum corner angles to add to the strength. The frame as well as the sash profiles have slots set aside so that the ⅛″ thick stainless steel reinforcing strips may be added for additional strength. An aluminum “dog bone” shape is inserted in mating frame profiles to join two frame sections together back-to-back. An aluminum “drip cap” similar in design to that used in old steel casement windows is used between the top of an operable sash and another window section above it. FIG. 25 illustrates various sash and frame combinations for perimeter and mullion situations.

The following examples illustrate various aspects of the invention but are not to be interpreted as limiting it. These examples are merely representative and are not inclusive of all the possible embodiments of the invention.

### EXAMPLE 1

### Thermal Performance Test

A casement window according to the invention was tested for its thermal performance.

Type: Fiberglass Casement Window

Test Procedure: The condensation resistance factor (CRF) and thermal transmittance (U) were determined in accordance with AAMA 1503-98, Voluntary Test Methodfor Thermal Transmittance and Condensation Resistance of Windows, Doors and Glazed Wall Sections.

| | |
|---|---|
| 1. Average warm side ambient temperature | 70.0 F. |
| 2. Average cold side ambient temperature | −0.3 F. |
| 3. 15 mph dynamic wind applied to test specimen exterior. | |
| 4. 0.0″ ± 0.04″ static pressure drop across specimen. | |

Test Results Summary:

| | | |
|---|---|---|
| 1. | Condensation resistance factor - Frame (CRF_{f}) | 74 |
| | Condensation resistance factor - Glass (CRF_{g}) | 67 |
| 2. | Thermal transmittance due to conduction (U_{c}) | 0.37 |
| | (U values expressed in Btu/hr · ft² · F) | |

Test Sample Description:

TABLE I
Construction:

| | Frame | Vent |
|---|---|---|
| Size | 48.00″ × 72.00″ | 46.38″ × 70.38″ |
| CORNERS | Mitered | Mitered |
| Fasteners | Keys & Screws | Keys & Screws |
| Sealant | Corners | Corners |
| MATERIAL | FG | FG |
| Color Exterior | White | White |
| Finish Exterior | FG | FG |
| Color Interior | White | White |
| Finish Interior | FG | FG |
| GLAZING METHOD | NA | Channel |

TABLE II
Glazing: (Sheet #1 is Exterior Sheet)

| | Sheet #1 | Gap #1 | Sheet #2 |
|---|---|---|---|
| THICKNESS | 0.135″ | 0.552″ | 0.253″ |
| COATING EMISSIVITY | 0.204 | NA | NA |
| COATING SURFACE | 2 | NA | NA |
| SPACER/SEALANT | NA | ZF | NA |
| MATERIAL | Annealed | 90% Argon* | Laminated |
| | | 10% Air* | |

Gas Filling Technique*: Single-Probe Timed
*Stated per Client/Manufacturer
NA-Non Applicable
See TABLE V for Description Codes

TABLE III
Components:

| Type | Quantity | Location |
|---|---|---|
| WEATHERSTRIP | | |
| Single leaf gasket | 1 Row | Frame perimeter |
| Wrapped foam gasket | 1 Row | Vent perimeter |
| HARDWARE | | |
| Quarter-turn lock | 2 | Lock stile |
| Metal keeper | 2 | Lock jamb |
| Full mortise butt hinge | 2 | Hinge stile |
| DRAINAGE | | |
| No weeps | | |

Condensation Resistance Factor:

1. Environmental systems started at 1535 hr., Mar. 28, 2000.

2. System was determined to be stable between 0555 and 0755 hr., Mar. 29, 2000.

The following information, condensed from the test data, was used to determine the condensation resistance factor:

| | | |
|---|---|---|
| T_{h =} | Warm side ambient air temperature | 70.0 F. |
| T_{c =} | Cold side ambient air temperature | −0.3 F. |
| FT_{P =} | Average of pre-specified frame temperatures (14) | 52.0 F. |
| FT_{r =} | Average of roving thermocouples (4) | 45.3 F. |
| W = | (FTₚ − FTᵣ)/[FTₚ − (T_{c} + 10)] × 0.40 | 0.064 |
| FT = | FT_{P}(1 − W) + W (FTᵣ) = Frame Temperature | 51.6 F. |
| GT = | Glass Temperature | 46.7 F. |
| CRF_{g =} | Condensation resistance, factor-Glass | 67 |
| | CRF_{g} = (GT − T_{c})/(Tₕ− T_{c}) × 100 | |
| CRF_{f =} | Condensation resistance factor-Frame | 74 |
| | CRF_{f} = (FT − T_{c})/(Tₕ− T_{c}) × 100 | |

The CRF number was determined to be 67. When reviewing this test data, it should be noted that the glass temperature (GT) was colder than the frame temperature (FT) therefore controlling the CRF number. Attached to this report is a copy of the “CRF Data Sheet” and the “Thermocouple Location Diagram” indicating average surface temperatures.

Thermal Transmittance:

| Tₕ | = Average warm side | 70.0 | F. |
|---|---|---|---|
| | ambient temperature | | |
| T_{c} | = Average cold side | −0.3 | F. |
| | ambient temperature | | |
| P | = Static pressure | 0.0 | psf |
| | difference across test | | |
| | specimen 15 mph dynamic | | |
| | perpendicular | | |
| | wind at exterior | | |
| Nominal sample area | | 24.00 | ft² |
| Total measured input to | | 691.7 | Btu/hr |
| calorimeter | | | |
| Calorimeter correction | | 61.4 | Btu/hr |
| Net specimen heat loss | | 630.3 | Btu/hr |
| U_{c} | = Thermal | 0.37 | Btu/hr · ft² · F |
| | Transmittance | | |

Glazing Deflection:

TABLE IV

| | Vent |
|---|---|
| | Glazing |
| Glazing thickness at edge | 0.94″ |
| Center glazing thickness upon receipt of specimen | 1.04″ |
| in laboratory (after stabilization) | |
| Center glazing thickness at laboratory ambient | 1.04″ |
| conditions on day of testing | |
| Center glazing thickness at test conditions | 0.93″ |

TABLE V
Description of Table Abbreviations

| CODE | FRAME/PANEL MATERIAL | DEFINITION |
|---|---|---|
| AI | Aluminum w/ vinyl inserts | Vinyl inserts employed in aluminum frame/sash |
| AL | Aluminum | No thermally broken frame/sash components |
| AP | Aluminum w/ thermal breaks - partial | Some frame/panel members thermally broken |
| AT | Aluminum w/ thermal breaks - all members | All members contain thermal breaks |
| AV | Aluminum/vinyl composite | Aluminum members combined with vinyl members |
| AW | Aluminum clad wood | Aluminum cladding covering primary wood members |
| FG | Fiberglass | Fiber reinforced frame/panel members |
| OT | Other | Material not described in this lookup table |
| PL | ABS Plastic | ABS plastic frame/sash members |
| ST | Steel | Steel alloy members |
| VA | Vinyl w/ reinforcing - all members | Some frame/panel members contain reinforcement |
| VC | Vinyl clad aluminum | Vinyl cladding covering primary aluminum members |
| VH | Vinyl w/ reinforcing - horizontal members only | Only horizontal panel members contain reinforcing |
| VI | Vinyl w/ reinforcing - interlock only | Only panel interlock members contain reinforcing |
| VP | Vinyl w/ reinforcing - partial | Only specific members contain reinforcing |
| VV | Vinyl w/ reinforcing - vertical members only | Only vertical panel members contain reinforcing |
| VW | Vinyl clad wood | Vinyl cladding covering primary wood members |
| VY | Vinyl | Vinyl members with no reinforcing |
| WA | Aluminum / wood composite | Aluminum members combined with wood members |
| WD | Wood | All members are solid wood |
| WV | Vinyl / wood composite | Vinyl members combined with wood members |

| | | | THERMAL |
|---|---|---|---|
| | | | BREAK |
| CODE | INTERSPACE GAS FILL | CODE | MATERIAL |
| AIR | Air | F | Foam |
| AR2 | Argon / Krypton mixture | O | Other |
| AR3 | Argon / Krypton / Air mixture | U | Urethane |
| ARG | Argon | V | Vinyl |
| CO2 | Carbon Dioxide | | |
| KRY | Krypton | | |
| OT | Other | | |
| SF6 | Sulfur Hexaflouride | | |

| CODE | SPACER TYPE | DEFINITION |
|---|---|---|
| A1 | Aluminum | Aluminum spacer system |
| A2 | Aluminum - thermally broken | Aluminum spacer with urethane thermal break |
| A3 | Aluminum - reinforced polymer | Polymer spacer with aluminum substrate |
| A4 | Aluminum / wood | Aluminum / wood composite |
| A5 | Aluminum reinforced butyl | Butyl spacer with aluminum substrate |
| A6 | Aluminum /foam/aluminum | Two aluminum spacers separated by foam |
| A7 | Aluminum U shaped | U shaped aluminum spacer embedded in sealant |
| FG | Fiberglass | Fiberglass spacer system |
| GL | Glass | Glass spacer system |
| PU | Polyurethane foam | Polyurethane foam |
| S1 | Steel | Stainless steel spacer system |
| S2 | Steel - thermally broken | Stainless steel spacer with urethane thermal break |
| S3 | Steel / foam / steel | Two steel spacers separated by foam |
| S4 | Steel U shaped | U shaped stainless steel spacer system |
| S5 | Steel reinforced butyl | Butyl spacer with steel substrate |
| V1 | Vinyl U shaped | U shaped spacer system embedded in sealant |
| WD | Wood | Wood spacer system |
| ZF | Silicone foam | Silicone foam spacer system |

### EXAMPLE 2

### Thermal Performance Test

A casement window according to the invention was tested for its thermal performance.

Type: Fiberglass Casement Window

Overall Size: 48.00″ wide by 72.00″ high

Representative Size: Non-Residential

Test Procedure: U-factor tests were performed in a Guarded Hot Box in accordance with NFRC 100-97, Procedure for Determining Fenestration Product Thermal Properties.

Test Results Summary:

Standardized U-factor (Uₛₜ): 0.37 Btu/hr·ft²·F (CTS Equivalent Procedure)

Test Sample Description:

Construction:

| | Frame | Vent |
|---|---|---|
| Size | 48.00″ × 72.00″ | 46.38″ × 70.38″ |
| CORNERS | Mitered | Mitered |
| Fasteners | Keys & Screws | Keys & Screws |
| Sealant | Corners | Corners |
| MATERIAL | FG | FG |
| Color Exterior | White | White |
| Finish Exterior | FG | FG |
| Color Interior | White | White |
| Finish Interior | FG | FG |
| GLAZING METHOD | NA | Channel |

Glazing: (Sheet #1 is Exterior Sheet)

| | Sheet #1 | Gap #1 | Sheet #2 |
|---|---|---|---|
| THICKNESS | 0.135″ | 0.552″ | 0.253″ |
| COATING EMISSIVITY | 0.204 | NA | NA |
| COATING SURFACE | 2 | NA | NA |
| SPACER/SEALANT | NA | ZF | NA |
| MATERIAL | Annealed | 90% Argon* | Laminated |
| | | 10% Air* | |

Gas Filling Technique*: Single-Probe Timed
*Stated per Client/Manufacturer
NA-Non Applicable
See table V for Description Codes

Components:

| Type | Quantity | Location |
|---|---|---|
| WEATHERSTRIP | | |
| Single leaf gasket | 1 Row | Frame perimeter |
| Wrapped foam gasket | 1 Row | Vent perimeter |
| HARDWARE | | |
| Quarter-turn lock | 2 | Lock stile |
| Metal keeper | 2 | Lock jamb |
| Full mortise butt hinge | 2 | Hinge stile |
| DRAINAGE | | |
| No weeps | | |

Test Conditions:

| | |
|---|---|
| t₁₁ = Average weather side ambient temperature | −0.3 F. |
| t₁ = Average room side ambient temperature | 70.0 F. |
| Metering room average relative humidity | 24% |
| Nominal 15-mph dynamic wind applied perpendicular to the | |
| test specimen exterior. | |
| Specimen was sealed during testing using clear tape. | |
| The pressure created by the dynamic wind was offset to create | |
| a pressure difference across specimen to 0.00″ ± 0.04″ H₂O, | |
| using make-up air. | |

Test Data:

Test Data:

| | | |
|---|---|---|
| A₅ = Projected specimen area | 24.00 | Ft² |
| Aₛₚ = Area of surround panel | 12.33 | Ft² |
| A_{mb} = Metering box area | 36.33 | Ft² |
| A_{b1} = Area of warm side baffle | 32.13 | Ft² |
| Q = Total measured input to meter box | 691.8 | Btu/hr |
| Qₛₚ = Surround panel heat loss | 33.7 | Btu/hr |
| Q_{mb} = Metering box heat loss | 23.0 | Btu/hr |
| Q_{fl} = Flanking loss. | 4.8 | Btu/hr |
| Qₛₚ = Net specimen heat loss | 630.3 | Btu/br |
| Uₛ = Thermal Transmittance of test specimen | 0.37 | Btu/hr^{·ft}^{²}^{·F} |
| Rₛ = Thermal Resistance of the test specimen | 2.68 | Btu/hr^{·ft}^{²}^{·F} |
| t₁ = Area-weighted warm side surface temperature | 51.8 | F |
| t₂ = Area-weighted cold side surface temperature | 4.7 | F |
| Equivalent warm side surface temperature | 50.8 | F |
| Equivalent cold side surface temperature | 4.7 | F |
| Area-weighted cold side frame surface temperature | 3.0 | F |
| Area-weighted warm side frame surface temperature | 53.0 | F |
| Area-weighted cold side edge-of-glass temperature | 4.4 | F |
| Area-weighted warm side edge-of-glass temperature | 43.4 | F |
| Area-weighted cold side center-of-glass temperature | 5.2 | F |
| Area-weighted warm side center-of-glass temperature | 53.3 | F |
| h₁ = Warm side surface conductance | 1.37 | Btu/hr^{·ft}^{²}^{·F} |
| h₁₁ = Cold side surface conductance | 5.25 | Btu/hr^{·ft}^{²}^{·F} |
| Cₛ = Thermal conductance of specimen | 0.57 | Btu/hr^{·ft}^{²}^{·F} |
| R_{c} = Surface-to-surface thermal resistance of specimen | 1.75 | hr^{·ft}^{²}·F/Btu |
| R₁ = Warm side surface resistance | 0.73 | hr^{·ft}^{²}·F/Btu |
| R₁₁ = Weather side surface resistance | 0.19 | hr^{·ft}^{²}·F/Btu |
| Rᵤ = Overall thermal resistance of specimen | 2.68 | hr^{·ft}^{²}·F/Btu |
| t_{b1} = Area-weighted baffle surface temperature | 70.4 | F |
| tₛₚ₁ = Surround panel warm side temperature | 66.9 | F |
| tₛₚ₂ = Surround panel cold side temperature | 0.9 | F |
| hₛₜ₁ = Warm side standardized surface conductance | 1.37 | Btu/hr^{·ft}^{²}^{·F} |
| hₛₜ₁₁ = Cold side standardized surface conductance | 5.10 | Btu/hr^{·ft}^{²}^{·F} |
| Uₛₜ = Standardized thermal transmittance of test | 0.37 | Btu/hr^{·ft}^{²}^{·F} |
| specimen | | |

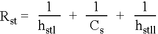

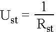

The reported standardized thermal transmittance (Uₛₜ) was determined using the CTS equivalent calculation procedure.

Glazing Deflection:

| | Glazing |
|---|---|
| Glazing thickness at edge | 0.94″ |
| Center glazing thickness upon receipt of specimen | 1.04″ |
| in laboratory (after stabilization) | |
| Center glazing thickness at laboratory ambient | 1.04″ |
| conditions on day of testing | |
| Center glazing thickness at test conditions | 0.93″ |

### EXAMPLE 3

### Structural Test

A structural test was performed on a casement window according to the invention.

Project Summary: Architectural Testing, Inc. (ATI) was contracted to perform tests on a Series/Model TE 6000, twin fiberglass casement window with transom lite. Test specimen description and results are reported herein.

Test Specification: The test specimen was evaluated in accordance with the following:

ASTM E 283-91, Standard Test Methodfor Determining the Rate of Air Leakage Through Exterior Windows, Curtain Walls, and Doors Under Specified Pressure Differences Across the Specimen.

ASTM E 330-97, Standard Test Methodfor Structural Performance of Exterior Windows, Curtain Walls, and Doors by Uniform Static Air Pressure Difference.

ASTM E 331-96, Standard Test Method for Water Penetration of Exterior Windows, Curtain Walls, and Doors by Uniform Static Air Pressure Difference.

Test Specimen Description:

Series/Model: TE 6000

Type: Twin Fiberglass Casement Window with Overhead Transom Fixed Lite

Overall Size: 3′3″ wide by 6′5″ high

(2) Vent Size: 1′7″ wide by 5′0-¼″ high

Transom: 3′2-¾″ wide by 1′3-¼″ high

Finish: All fiberglass was white.

Glazing Details: The vents and transom lites utilized 1,00″ thick, sealed insulating glass fabricated from two sheets of 3/16″ thick clear annealed glass and a desiccant filled metal spacer system. The sealed insulating glass was channel glazed in a silicone seal to both the interior and exterior of the glass.

Weatherstripping:

| Description | Quantity | Location |
|---|---|---|
| Custom single leaf vinyl | 1 Row | Vent perimeter |
| compression gasket | | |
| ¼″ diameter hollow vinyl | 1 Row | Top rail |
| bulb seal | | |

Frame Construction: The frame was constructed of fiberglass pultrusion members and all corners were mitered, keyed, sealed, and fastened with two screws per corner. The astragal was fastened to the sill and mullion with silicone and two screws per end.

Vent Construction: The vent was constructed of fiberglass pultrusion members and all corners were mitered, keyed, sealed, and fastened with four screws per corner.

Mullion Construction: The mullion was constructed of two fiberglass pultrusions members. The “L” shaped members were butted and sealed with silicone. The mullion was fastened to the jambs with silicone and four screws per end.

Hardware:

| Description | Quantity | Location |
|---|---|---|
| Cast bronze handle | 4 | 15″ o.c. from stile ends with keepers |
| lock with keeper | | aligned on jamb |
| Metal door hinge | 6 | (2) 6″ o.c. from stile ends, |
| | | (1) midspan of hinge stile |

Reinforcement: The vent was reinforced with a 1″ wide by ⅛″ thick stainless steel flat bar. The mullion was reinforced with two extruded aluminum inserts.

Installation: The window was fastened into the 3″×8″ aluminum channel test buck with four screws per jamb and three screws per head and sill. The exterior perimeter was sealed with silicone.

Test Results:

The results are tabulated as follows:

| Specification | Title of Test | Results | Allowed* |
|---|---|---|---|
| ASTM E 283 | Air | <0.01 cfm/ft² | 0.10 cfm/ft² max. |
| | Infiltration | | |
| | @ 6.24 psf | | |
| | (50 mph) | | |
| ASTM E 331 | Water | No entry | No entry |
| | Resistance | | |
| | WTP = 12.00 psf | | |
| ASTM E 330 | Uniform Load | | |
| | Structural | | |
| | @ 82.50 psf | 0.08″ | 0.24″ max. |
| | (exterior) | | |
| | @ 82.50 psf | 0.03″ | 0.24″ max. |
| | (interior) | | |

*Allowed values are referenced from AAMA/NWWDA 101/I.S.2-97.

### EXAMPLE 4

### Acoustical Performance Test

An acoustical performance test was performed on a casement window according to the invention.

Type: Fiberglass Casement

Overall Size: 48.00″×72.00″

Glazing: 1″ IG (¼″ Laminated, ⅝″ Air, ⅛″ Annealed)

Project Scope: Architectural Testing, Inc. (ATI) was contracted by Tempest Architectural Products, Inc. to conduct a sound transmission loss test on a Series/Model TE 6000, fiberglass casement window. A summary of the results is listed in the Test Results section and the complete test data is included as Appendix C of this report.

Test Methods: The acoustical tests were conducted in accordance with the following:

ASTM E 90-97, Standard Test Method for Laboratory Measurement of Airborne Sound Transmission Loss of Building Partitions.

ASTM E 413-87 (Re-approved 1999), Classification for Rating Sound Insulation.

ASTM E 1332-90 (Re-approved 1998), Standard Classification for Determination of Outdoor-Indoor Transmission Class.

Test Equipment: The equipment, used to conduct these tests, meets the requirements of ASTM E 90-97. The microphones were calibrated before conducting sound transmission loss tests. The test equipment and test chamber descriptions are listed in TABLE VI

Test Procedure:

The sound transmission loss test was initially performed on a filler wall that was designed to test 4′0″ by 6′0″ and 6′0″ by 4′0″ specimens. The filler wall achieved an STC rating of 63.

A wood frame was placed around the outside perimeter of the window. Silicone caulk was used to seal the window frame to the wood frame. The 4′0″ by 6′0″ plug was removed from the filler wall assembly and the test specimen was installed in the opening. The interior side of the window frame, when installed, was approximately ¼″ from being flush with the receive room side of the filler wall. A dense neoprene gasket and duct seal was used to seal the wood frame to the inside perimeter of the filler wall opening. A stethoscope was used to check for any abnormal air leaks before the test.

One background noise sound pressure level, and five sound absorption measurements were conducted at each of the five microphone positions. Two sound pressure level measurements were made simultaneously in both rooms, at each of the five microphone positions. The air temperature and relative humidity conditions were monitored and recorded during the background, absorption, source and receive room measurements.

Sample Descriptions:

Construction

| | Frame | Vent |
|---|---|---|
| Size | 48.00″ × 72.00″ | 46.38″ × 70.38″ |
| CORNERS | Mitered | Mitered |
| Fasteners | Keys & Screws | Keys & Screws |
| Seal Method | Comers | Corners |
| MATERIAL | FG | FG |
| Thermal Break Material | NA | NA |
| GLAZING METHOD | NA | Channel Glazed |
| | | Daylight Opening Size = |
| | | 44.50″ × 68.50″ |

Vent Glazing: (Sheet #1 is Exterior Sheet)

| | Sheet #1 | Gap #1 | Sheet #2 |
|---|---|---|---|
| MEASURED THICKNESS | 0.118″ | 0.612″ | 0.105″, 0.030″, 0.105″ |
| EMISSIVITY COATING | NA | NA | NA |
| COATING SURFACE | NA | NA | NA |
| SPACER/SEALANT | NA | PU | NA |
| MUNTIN PATTERN | NA | NA | NA |
| MATERIAL | Annealed | Air* | Laminated |

Components:

| TYPE | QUANTITY | LOCATION |
|---|---|---|
| WEATHERSTRIP | | |
| Single leaf gasket | 1 Row | Frame perimeter |
| Wrapped foam gasket | 1 Row | Vent perimeter |
| HARDWARE | | |
| Quarter-turn lock | 2 | Lock stile |
| Metal keeper | 2 | Lock jamb |
| Full mortise butt hinge | 2 | Hinge stile |
| DRAINAGE | | |
| No weeps | | |

Test Results: The STC (Sound Transmission Class) rating was calculated in accordance with ASTM E 413-87. The OITC (Outdoor-Indoor Transmission Class) was calculated in accordance with ASTM E 1332-90. A summary of the sound transmission loss test results on the window is listed below.

| ATI Job | | | |
|---|---|---|---|
| File No. | Sample Description | STC | OITC |
| 01-37028.01-1 | Series/Model TE 6000, fiberglass | 33 | 26 |
| | casement window with 1″ | | |
| | insulating glass (¼″ | | |
| | laminated, ⅝″ airspace, | | |
| | ⅛″ annealed) | | |

TABLE VI
Instrumentation:

| | | |
|---|---|---|
| 1. | Analyzer: | Hewlett Packard Model 35670A, Dynamic |
| | | Signal Analyzer. |
| 2. | Receive room | Hewlett Packard (ACO), model ACOJ 7047 |
| | microphone: | ½″ pressure type, condenser microphone. |
| 3. | Source room | Hewlett Packard (ACO), model ACOJ 7047 |
| | microphone: | ½″ pressure type, condenser microphone. |
| 4. | Microphone | Bruel & Kjaer, Type 4228 Pistonphone |
| | calibrator: | Calibrator, 124 dB at 250 hertz. |
| 5. | Noise source: | Two, non-coherelated “Pink” noise signals |
| | | generated by a Delta Electronics, Type |
| | | SNG-1 Stereo Noise Generator. |
| 6. | Spectrum shaper: | Rane Type RPE228 Programmable EQ. |
| 7. | Power amplifiers | Two Renkus-Heinz Model P2000 Amplifiers. |
| 8. | Receive room | Two Renkus-Heinz “Trap Jr/9” loudspeakers. |
| | loudspeakers: | |
| 9. | Source room | Two Renkus-Heinz “Trap Jr/9” loudspeakers. |
| | loudspeakers: | |

Test Chamber Descriptions:

| | | |
|---|---|---|
| 1. | Receive Room: | Volume = 8,291.3 ft³ (234 m³). |
| | | Rotating vane and stationary diffusers. |
| | | Temperature & humidity controlled. |
| | | Isolation pads under the floor. |
| 2. | Source Room: | Volume = 7296.3 ft³ (206.6 m³). |
| | | Stationary diffusers only. |
| | | Temperature & humidity controlled. |
| 3. | TL Test Opening | Size = 14 ft wide by 10 ft high. Vibration |
| | | break between source and receive rooms. |

The invention now being fully described, it will be apparent to one of ordinary skill in the art that many changes and modifications can be made thereto without departing from the spirit or scope of the invention as set forth herein.

What is claimed is:

1. A casement window or door comprised of a glass unit and pultruded fiberglass lineals which are formed into a sash frame and a main frame having narrow sightlines; wherein the window is thermally and acoustically efficient.

2. The casement window according to claim 1, wherein the window further has a lower air infiltration and a higher resistance to water penetration than traditional steel casement windows.

3. A casement window or door comprising:
a glass unit;
a glazing space for said glass unit; and
a frame made of a thermally efficient material;
wherein said glass unit and said frame are structurally bonded to combine the strength of the glass with the strength of the frame to produce a casement window or door that is thermally and acoustically efficient.

4. The casement window according to claim 3, wherein said glass unit is insulated glass.

5. The casement window according to claim 3, wherein said glazing space accommodates glazing up to one inch thick.

6. The casement window according to claim 3, wherein said thermally efficient frame material is pultruded fiberglass.

7. The casement window according to claim 3 wherein said frame has grooves and slots for the incorporation of a weather stripping material.

8. The casement window according to claim 7 wherein said weather stripping material is selected from the group consisting of co-extruded dual durometer gaskets, foam filled bulb gaskets, generic vinyl bulb gaskets, other thermoplastic bulb or lip gaskets and other conventional weather stripping materials.

9. The casement window according to claim 3, further comprising a sash system.

10. The casement window according to claim 9, wherein said sash system is structurally glazed.

11. The casement window according to claim 10, wherein said sash system comprises fiberglass sash profiles which are u-shaped pieces that fit around the edges of a glass unit; and a structural sealant to bond the glass and fiberglass sash profiles together.

12. The casement window according to claim 11, wherein said sealant is selected from the group consisting of silicones, urethanes or polysulfides.

13. The casement window according to claim 3 wherein said frame is comprised of pultruded fiberglass lineals which are formed into a frame having a narrow sightline; wherein the window is thermally and acoustically efficient.

14. The casement window according to claim 3, wherein the window further has a lower air infiltration and a higher resistance to water penetration than steel casement windows.

15. The casement window according to claim 3, wherein the frame consists of a sash frame and a main frame.

16. The casement window according to claim 15, wherein said sash frame has a substantial sloped surface portion.
